(19) United States
(12) Patent Application Publication
(10) Pub. No.: US 2002/0130971 A1
(43) Pub. Date: Sep. 19, 2002

(54) Device for reducing noise in image signals

(76) Inventor: Gerhard Wischermann, Weiterstadt (DE)

Correspondence Address: U.S. Philips Corporation, 580 White Plains Road, Tarrytown, NY, 10591, US

(21) Appl. No.: 10/084,853

(22) Filed: Feb. 26, 2002

(30) Foreign Application Priority Data
Feb. 28, 2001 (DE) 10109585.6

(51) Int. Cl. H04N 5/08; H04N 7/04

(52) U.S. Cl. 348/533; 348/470

(57) ABSTRACT

In a device for reducing noise in image signals, the image signals passing through a temporal recursive filter whose feedback factor is a function of movement in the images represented by the image signals, in order to form the feedback factor for the respective current image, a first and a second factor are combined in such a way that the smaller one of the factors substantially determines the feedback factor. The first factor is formed from the feedback factor of the preceding image, and the second factor is calculated from the difference between the preceding image and the current image.

The invention relates to a device for reducing noise in image signals, the image signals passing through a temporal recursive filter whose feedback factor is a function of movement in the images represented by the image signals.

Devices that have temporal recursive filters for reducing noise in image signals have been disclosed, for example by DE 27 50 173 C2. In this case, the higher the feedback factor, the better the reduction in noise, because then in the final analysis the image content of many images is averaged. However, in the case of moving image contents it is possible to integrate from image to image only within limits, since otherwise blurring of the moving image contents occurs. Consequently, in the known devices the feedback factor is controlled as a function of a movement in the image. The movement is determined by forming the absolute value of the differences between the image signals of two consecutive images.

In this case, the image signals used for forming the movement signal are subjected to low-pass filtering in order to avoid influencing the noise component when forming the movement signal. It is disadvantageous in this method that the feedback factor can rise suddenly if the movement signal becomes very small, and this leads to a high time constant for the filter.

This disadvantage is avoided in the case of another method, disclosed by DE 197 84 721 C2, by virtue of the fact that the feedback factor is increased in a stepwise fashion in such a way that the reduction in noise rises more quickly. In this case, the feedback factor for the current image is controlled as a function of the feedback factor of the last image and a moved/unmoved decision. An accumulator counts the number C of the unmoved images and ensures a stepwise rise in K. This leads, in particular, to an improvement inside the first image at the start of a new scene. This second known method has, however, the disadvantage that the accumulator is reset to zero when the movement signal rises above a specific adjustable value. The sudden resetting, associated therewith, of the feedback factor has an extremely disturbing effect in the case of specific situations.

It is the object of the present invention to specify a device for reducing noise, in the case of which the reduction in noise approaches as quickly as possible a value which is optimally adapted to the movement respectively present.

This object is achieved with the aid of the device according to the invention by virtue of the fact that in order to form the feedback factor for the respective current image, a first and a second factor are combined in such a way that the smaller of the factors substantially determines the feedback factor, in that the first factor is formed from the feedback factor of the preceding image, and in that the second factor is calculated from the difference between the preceding image and the current image. The respectively smaller one of the factors is preferably taken into account by virtue of the fact that the respectively smaller one of the factors serves as feedback factor.

A first advantageous refinement of the device according to the invention consists in that the first factor is formed by dividing a constant by a further constant minus the feedback factor of the preceding image. It is preferably provided in this case that the first factor (P) is calculated as in the equation P=1/(2−O), O being the feedback factor of the preceding image.

Another advantageous refinement consists in that the second factor is formed by dividing a limiting value (E) by the absolute value of the difference between the preceding and the current image. It is preferably provided in this case that the second factor (L) is formed by means of the equation L=E/³X−Y³ [sic], X being the current image, Y the preceding image and E the limiting value.

Exemplary embodiments of the invention are illustrated in the drawings in a plurality of figures, and explained in more detail in the following description. In the figures:

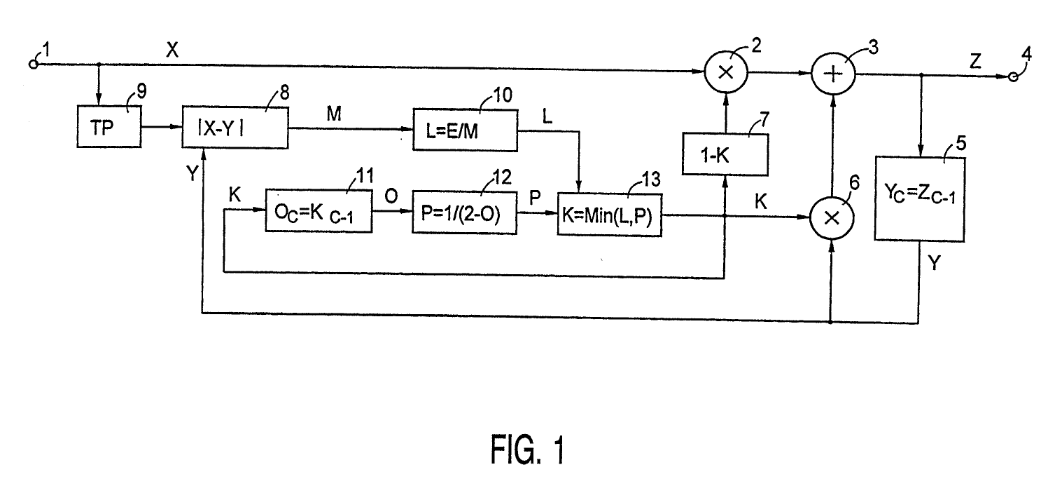

FIG. 1 shows a block diagram of the exemplary embodiment,

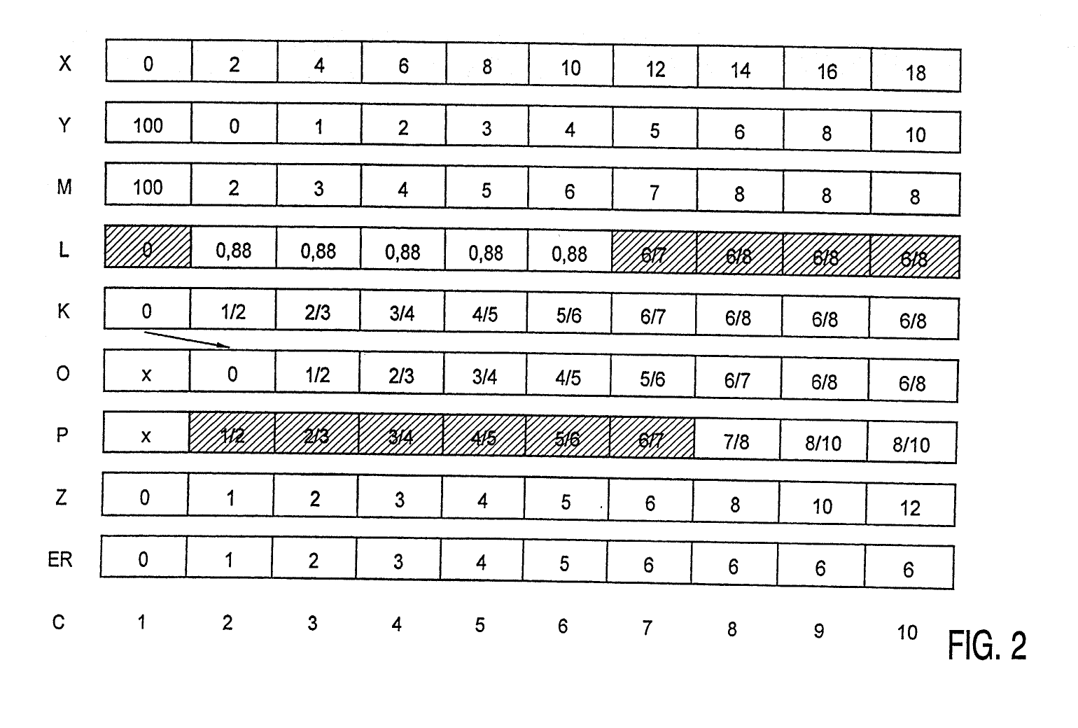

FIG. 2 a scheme with a numerical representation of the signals occurring in the case of the block diagram, according to FIG. 1, and

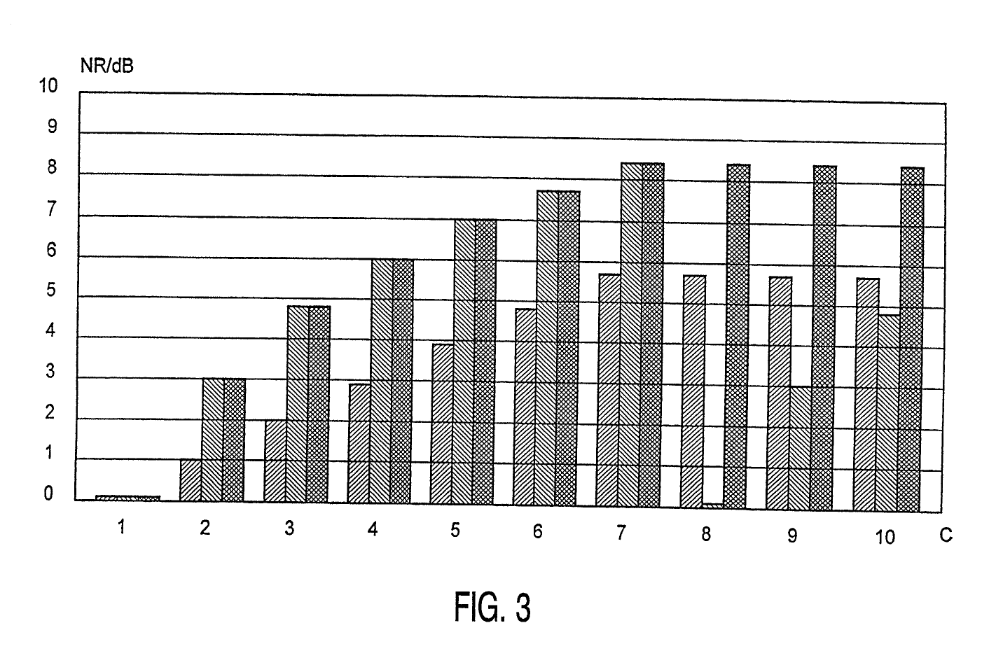

FIG. 3 shows a comparison of the reduction in noise according to the known method and with the aid of the device according to the invention.

The representation as a block diagram does not constitute a statement that the individual functions are actually carried out in individual circuits. Rather, it is possible and advantageous to apply programmable processors for carrying out the calculations.

The device according to FIG. 1 is fed the image signal X via an input 1. It passes via a multiplier 2 and an adder 3 to the output 4 as image signal Z. The image signal Z is led to a image memory 5, and read out from the image memory as signal Y in a fashion delayed by an image period. The read-out image signal Y is fed to the adder 3 via a second multiplier 6. The multiplier 6 is fed the feedback factor K and the multiplier 2 is fed a factor 1−K via a circuit 7.

To this extent, the device according to FIG. 1 includes a known recursive filter. If K=0, X is relayed to the output 4 without change. In the case of K=0, no reduction in noise takes place. As X becomes larger, the proportion of the signal Y read out from the image memory 5 becomes larger in the output signal Z. While K=1 it is only the stored image signal that is now read out and written in again. The maximum value of K is held slightly below 1 for reasons of stability. Consecutive images in the image memory 5 are then averaged such that statistical disturbances (noises) are reduced.

The feedback factor K is derived as follows in the case of the device according to FIG. 1: firstly, at 8 the absolute value is formed of the difference between the respectively fed (current) image X and the preceding image Y. In this process, the image X is subjected to low-pass filtering 9 such that high-frequency components (noises) are suppressed so that they are not detected as movement. At 10, a limiting value E is divided by the output signal M of the circuit 8, thus producing a first factor L. L is smaller the more that movement is established between two consecutive images.

A second factor P is formed from the feedback factor K of the preceding image by virtue of the fact that the feedback factor of the preceding image is firstly delayed by one image at 11. In this case O_{C} is the feedback factor respectively relayed to 12, which corresponds to the feedback factor K_{C-1} of the preceding image. The delay factor O is then subjected at 12 to the operation of P=1/(2−O), the second factor P being produced thereupon. At 13 the respectively smaller one of the two factors L and P is selected and used as feedback factor K to control the recursive filter.

FIG. 2 shows various signals for ten images in each case, which are marked with the aid of a counter C=1 . . . 10. It may be assumed that the input signal rises monotonically with the start of a new scene from image to image, with the values 0, 2, 4, etc. In the first image represented, the signal Y has a greatly different value, for example 100, from a previous scene, and so the movement signal M firstly likewise has the value 100, and then rises gradually again over 2, 3, 4 to 8. In the representation according to FIG. 2, the value 6 is taken as limiting value E. Moreover, L is limited to 0.88. Given the values for M specified for C=1. . . . 10, L firstly rises from 0 to 0.88, and then falls to 6/7 in the seventh image, and then further to 6/8.

As yet to be set forth with the aid of the rows represented further below, L is greater than P in the case of the sixth image. The feedback factor K then initially follows the second factor P and does not correspond to the factor L until the seventh image. O is formed from K by means of the delay by one image at 11 (FIG. 1). The delay is symbolized in FIG. 2 by an arrow. P is then derived from O. This factor is smaller than L up to the sixth image, then assumes the same value as L at the seventh image, and then becomes larger such that thereafter the value L is decisive for the feedback factor K. Those values of L and P from which K is formed are hatched in FIG. 2. The values of O and P for the first image are marked with an x in FIG. 2, since these depend on the prehistory which is unknown from the point of view of FIG. 2.

In a further row of FIG. 2, there is then represented the signal Z=(1−K)X+KY which rises more slowly than the input signal X because of the recursive filtering, an error ER thereby being produced.

FIG. 3 shows for the monotonically rising image sequence explained in conjunction with FIG. 2 the theoretical profile of the reduction in noise with the aid of the known methods mentioned at the beginning (hatched once in each case) and with the aid of the invention (cross-hatched) by way of comparison. The decisive improvement as against the second known method is that the feedback factor K does not jump back to 0 when the moving threshold (eighth image) is reached. The reduction in noise thereby remains at a high level and no erratic artifacts occur in the output image. By comparison with the first known method, the invention results in a faster buildup of the reduction in noise at the start of a phase of still images.

1. A device for reducing noise in image signals, the image signals passing through a temporal recursive filter whose feedback factor is a function of movement in the images represented by the image signals, wherein,
in order to form the feedback factor (K) for the respective current image, a first (P) and a second (L) factor are combined in such a way that the smaller one of the factors (L, P) substantially determines the feedback factor (K), in that the first factor (P) is formed from the feedback factor (O) of the preceding image, and in that the second factor (L) is calculated from the difference between the preceding image (Y) and the current image (X).

2. The device as claimed in claim 1, wherein
the respectively smaller one of the factors (L, P) serves as feedback factor (K).

3. The device as claimed in claims 1 or 2, wherein
the first factor (P) is formed by dividing a constant by a further constant minus the feedback factor (O) of the preceding image.

4. The device as claimed in claim 3, wherein
the first factor (P) is calculated as in the equation P=1/(2-O), O being the feedback factor of the preceding image.

5. The device as claimed in one of the preceding claims, wherein
the second factor (L) is formed by dividing a limiting value (E) by the absolute value of the difference between the preceding (Y) and the current (X) image.

6. The device as claimed in claim 5, wherein
the second factor (L) is formed by means of the equation L=E/[X−Y], X being the current image, Y the preceding image and E the limiting value.
